(19) United States
(12) Patent Application Publication
(10) Pub. No.: US 2023/0131014 A1
(43) Pub. Date: Apr. 27, 2023

(54) COMBUSTION DEVICE

(71) Applicant: NORITZ CORPORATION, Hyogo (JP)

(72) Inventors: Shinsuke Hashimoto, Hyogo (JP); Shogo Miyamoto, Hyogo (JP)

(73) Assignee: NORITZ CORPORATION, Hyogo (JP)

(21) Appl. No.: 17/964,894

(22) Filed: Oct. 12, 2022

(30) Foreign Application Priority Data
Oct. 22, 2021 (JP) 2021-172903

(51) Int. Cl. F23N 1/00

(52) U.S. Cl. CPC F23N 1/005; F23N 2225/08; F23N 2235/16; F23N 2239/04; F23N 2241/04

(57) ABSTRACT

The disclosure provides a combustion device for burning LP gas filled in a gas cylinder as fuel in a combustion unit. The combustion device includes: a control unit for controlling a combustion operation based on a preset operation table such that a combustion output reaches a target output, and an output detection part for detecting the combustion output. In a case where the combustion output detected by the output detection part is risen by a reference value or more relative to the target output, the control unit notifies of a lowering in the remaining amount of LP gas in the gas cylinder.

### CROSS-REFERENCE TO RELATED APPLICATION

This application claims the priority benefits of Japanese Application No. 2021-172903, filed on Oct. 22, 2021. The entity of the above-mentioned patent application is hereby incorporated by reference herein and made a part of this specification.

### BACKGROUND

### Technical Field

The disclosure relates to a combustion device using LP gas as fuel.

### Related Art

### Description of the Related Art

Conventionally, a combustion device that burns fuel gas has been used, for example, by being installed in a hot water supply device that uses combustion heat to supply hot water. The fuel gas includes city gas supplied from a supplier through a gas pipe, and LP gas filled in gas cylinders configured for each user by the supplier.

Since the amount of LP gas that may be filled in a gas cylinder is limited, it is necessary to replace the gas cylinder when the remaining amount of LP gas decreases. For this reason, LP gas suppliers regularly check the remaining amount, etc., and replace gas cylinders as necessary to prevent running out of fuel. However, it is a heavy burden for the inspectors to visit the gas cylinder placement locations one by one.

For this reason, a method of managing the remaining amount in the gas cylinder based on the weight of the gas cylinder, the supply flow rate of the LP gas, the temperature, and the like is known, for example, as disclosed in Patent Literature 1 (JP 2019-138325). Moreover, as disclosed in Patent Literature 2 (JP 4314942), in a fuel cell where LP gas is reformed and used for power generation, there is known a technique for controlling the supply flow rate of LP gas to a reformer such that the amount of hydrogen gas after reforming is constant, based on the relationship between the residual pressure of the gas cylinder and the butane concentration in the LP gas.

However, Patent Literature 1 requires a device for measuring the weight of the gas cylinder, it is costly and not easy to implement. Therefore, it is conceivable to detect the remaining amount in the gas cylinder based on the relationship between the residual pressure of the gas cylinder and the butane concentration in the LP gas as disclosed in Patent Literature 2, but there are cases where the residual pressure cannot be obtained from the gas meter. Moreover, since it is sufficient to know when it is time to replace the gas cylinder, there is no need to constantly monitor the remaining amount in the gas cylinder as disclosed in Patent Literature 2.

The disclosure provides a combustion device capable of easily detecting a lowering in the remaining amount of LP gas and notifying the arrival of the time to replace the gas cylinder.

### SUMMARY

The combustion device of technical solution 1 of the disclosure is a combustion device for burning LP gas filled in a gas cylinder as fuel in a combustion unit. The combustion device includes: a control unit for controlling a combustion operation based on a preset operation table such that a combustion output reaches a target output, and an output detection part for detecting the combustion output. In response to the combustion output detected by the output detection part being risen by a reference value or more relative to the target output, the control unit notifies of a lowering in the remaining amount of LP gas in the gas cylinder.

According to technical solution 1 of the disclosure, the combustion device of technical solution 2 of the disclosure includes: a flame temperature sensor for detecting a flame temperature in the combustion unit as the output detection part. When controlling the combustion operation based on the operation table, in response to a temperature detected by the flame temperature sensor being risen by a certain amount or more from a reference temperature, the control unit determines that the combustion output is risen by a reference value or more.

According to technical solution 1 of the disclosure, the combustion device of technical solution 3 of the disclosure includes: a combustion fan for supplying combustion air to the combustion unit as the output detection part. When controlling the combustion operation based on the operation table and adjusting the combustion output so as to reach the target output, in response to a rotational speed of the combustion fan being decreasingly corrected by a certain amount or more from a reference rotational speed, the control unit determines that the combustion output is risen by a reference value or more.

According to technical solution 1 of the disclosure, the combustion device of technical solution 4 of the disclosure includes: a gas proportional valve for adjusting a supply flow rate of the LP gas as the output detection part. When controlling the combustion operation based on the operation table and adjusting the combustion output so as to the target output, in response to an opening of the gas proportional valve being decreasingly corrected by a certain amount or more from a reference opening, the control unit determines that the combustion output is risen by a reference value or more.

### BRIEF DESCRIPTION OF THE DRAWINGS

FIG. 1 is a diagram showing a hot water supply device including a combustion device according to an embodiment of the disclosure.

FIG. 2 is an example of an operation table in which combustion operation conditions are set.

### DESCRIPTION OF THE EMBODIMENTS

According to the configuration, when performing combustion operation based on the operation table, in a case where the combustion output is risen by a reference value or more relative to the target output, the control unit of the combustion device notifies that the remaining amount of LP gas in the gas cylinder has lowered and is getting less. As the remaining amount of LP gas in the gas cylinder decreases and the time for replacement approaches, the ratio of butane having a large heating value relative to the main component propane increases. Thus, the combustion output increases more than the combustion operation based on the operation table. Therefore, the control unit is capable of detecting a lowering in the remaining amount of LP gas by detecting the combustion output through the output detection part, and notifying the arrival of the time to replace the gas cylinder to prompt the replacement of the gas cylinder by notifying that the remaining amount of LP gas has decreased.

According to the configuration, the control unit performs the combustion operation based on the operation table, and determines that the combustion output is risen by the reference value or more when the flame temperature in the combustion unit is risen by a certain amount or more from a reference temperature set in the operation table. Therefore, it is possible to notify a lowering in the remaining amount of LP gas, which causes the combustion output to rise by the reference value or more, and to prompt the replacement of the gas cylinder.

According to the configuration, when performing combustion operation based on the operation table and adjusting the combustion output to reach the target output, in a case where the rotational speed of the combustion fan is decreasingly corrected by a certain amount or more from the reference rotational speed set in the operation table so as to lower the combustion output, the control unit determines that the combustion output is risen by the reference value or more. Therefore, it is possible to notify a lowering in the remaining amount of LP gas, which causes the combustion output to rise by the reference value or more, and to prompt the replacement of the gas cylinder.

According to the configuration, when performing combustion operation based on the operation table and adjusting the combustion output to reach the target output, in a case where the opening of the gas proportional valve is decreasingly corrected by a certain amount or more from the reference opening set in the operation table so as to lower the combustion output, the control unit determines that the combustion output is risen by the reference value or more. Therefore, it is possible to notify a lowering in the remaining amount of LP gas, which causes the combustion output to rise by the reference value or more, and to prompt the replacement of the gas cylinder.

According to the combustion device of the disclosure, it is possible to easily detect a lowering in the remaining amount of LP gas and notify the arrival of the time to replace the gas cylinder.

Hereinafter, the aspects for implementing this disclosure is explained based on embodiments.

A combustion device that bums LP gas as fuel will be described by taking a hot water supply device having this combustion device as an example.

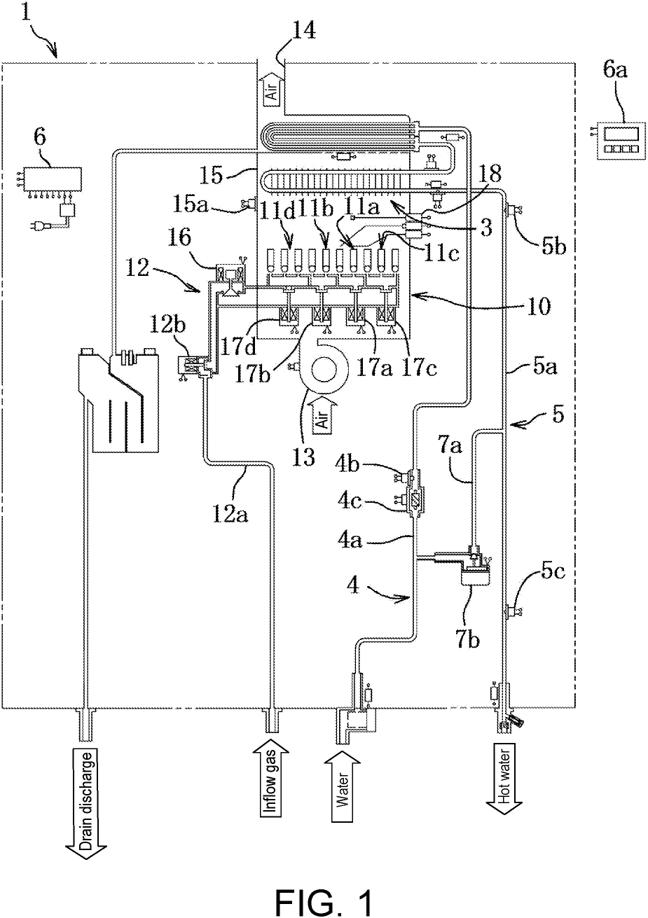

As shown in FIG. 1, a hot water supply device 1 includes a combustion device 10, a heat exchange unit 3 for heating hot water using combustion heat of the combustion device 10; a water supply unit 4 for supplying tap water to the heat exchange unit 3; a hot water tapping unit 5 for adjusting the temperature of the hot water heated by the heat exchange unit 3 and tapping the hot water; and a control unit 6 for controlling combustion operation of the combustion device 10 and temperature adjustment of the hot water tapping unit 5, and an operation terminal 6a. The operation terminal 6a has, for example, operation switches and a display for setting hot water supply target temperature of the hot water supply device 1, and is connected to the control unit 6.

In the combustion device 10, the combustion unit for burning the LP gas as fuel has a plurality of combustion stages 11a-11d, and includes a gas supply unit 12 for supplying LP gas to the combustion unit, a combustion fan 13 for supplying combustion air to the combustion unit, and a can body case 15 for housing the combustion unit so as to guide the combustion exhaust after burning the LP gas to an exhaust port 14.

The gas supply unit 12 includes a gas passage 12a, a gas passage on-off valve 12b for switching the gas passage 12a on and off; a gas proportional valve 16 for adjusting the supply flow rate of LP gas; and a plurality of combustion stage on-off valves 17a-17d for switching between supplying and stopping the LP gas to the plurality of combustion stages 11a-11d. The combustion device 10 is capable of adjusting the combustion output from the case of maximizing the combustion output by burning all of the plurality of combustion stages 11a-11d to the case of minimizing the combustion output by burning only one of the combustion stages 11a, and by adjusting the opening of the gas proportional valve 16, the combustion output may be finely adjusted even with the same number of combustion stages. A flame temperature sensor 18 is disposed above the combustion stage 11a to detect the flame temperature in the combustion unit.

The rotational speed of the combustion fan 13 is adjusted by the control unit 6 so as to adjust the flow rate of the combustion air supplied according to the combustion output. A can body temperature sensor 15a is provided outside the can body case 15, and when the can body temperature sensor 15a detects an abnormal temperature rise (e.g. a rise of 50° C. or more), for example, the control unit 6 stops combustion to ensure safety.

The water supply unit 4 includes a water supply passage 4a for supplying tap water to the heat exchange unit 3, a water supply temperature sensor 4b for detecting the temperature of tap water (water supply temperature) and a water supply flow rate sensor 4c for detecting the flow rate of tap water supplied to the heat exchange unit 3.

The hot water tapping unit 5 includes a hot water tapping passage 5a for supplying the hot water heated in the heat exchange unit 3 to the outside, a bypass passage 7a branched from the water supply passage 4a and connected to the hot water tapping passage 5a for supplying tap water of the water supply passage 4a to the hot water tapping passage 5a; and a flow rate regulating valve 7b for adjusting the flow rate of tap water in the bypass passage 7a. The hot water tapping passage 5a includes a first hot water tapping temperature sensor 5b for detecting the temperature of the hot water heated in the heat exchange unit 3, and a second hot water tapping temperature sensor 5c for detecting the temperature of the hot water that is mixed with the tap water from the bypass passage 7a and temperature-controlled.

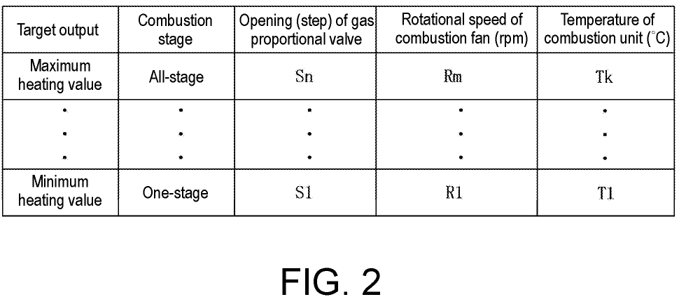

When the water supply flow rate sensor 4c detects a flow rate equal to or higher than a predetermined flow rate, the control unit 6 sets a target output of the combustion operation of the combustion device 10 based on the water supply flow rate, the water supply temperature, and the hot water supply target temperature. Moreover, the combustion stage for combustion, the opening of the gas proportional valve 16, and the rotational speed of the combustion fan 13 are set based on the operation table for combustion operation stored in the control unit 6 as shown in FIG. 2, for example, and the combustion operation is started.

In the operation table, for example, the reference number of combustion stages, a reference opening of the gas proportional valve 16, a reference rotational speed of the combustion fan 13, and a reference temperature of the flame in the combustion unit are determined as reference operating conditions for the combustion operation corresponding to the target output. The reference operating conditions are preset based on a combustion experiment in which LP gas having a predetermined composition is burned such that the number of combustion stages for combustion, the opening of the gas proportional valve 16, the rotational speed of the combustion fan 13, and the flame temperature of the combustion unit respectively increase as the target output increases. The LP gas having the predetermined composition is, for example, 90 [mol %] of propane and 10 [mol %] of butane, but is not limited thereto.

LP gas is a mixed gas containing propane as a main component and hydrocarbons such as butane, which is filled in a gas cylinder in a liquefied state. LP gas is supplied to the combustion device 10 from this gas cylinder. The filling amount of LP gas in a gas cylinder is limited, so the gas cylinder is replaced so as not to run out of fuel.

Propane has a lower boiling point than butane and is easily vaporized, so when there is a large amount of LP gas remaining in the gas cylinder, propane accounts for a large proportion of the supplied LP gas. On the other hand, as the remaining amount of LP gas in the gas cylinder decreases, the proportion of propane decreases and the proportion of butane increases even if the supply flow rate of LP gas is the same.

Since the vaporized butane generates more heat during combustion than the vaporized propane of the same amount (same volume), when the supply flow rate of LP gas is constant, the combustion output of the combustion device 10 rises as the remaining amount of LP gas decreases. Therefore, by detecting a rise (e.g. a rise of 20% or more) in the combustion output by a reference value or more through output detection part, the control unit 6 determines that the remaining amount of LP gas has decreased, and notifies of a lowering in the remaining amount so as to prompt the replacement of the gas cylinder.

Since the combustion device 10 includes the flame temperature sensor 18, the flame temperature sensor 18 is used as the output detection part, for example. In the operation table of FIG. 2, based on the combustion experiment, the flame temperature assumed to be detected by the flame temperature sensor 18 as the temperature of the combustion unit during the combustion operation is preset for each target output as a reference temperature. Moreover, the can body temperature sensor 15a may also be used as output detection part, and the reference temperature assumed to be detected by the can body temperature sensor 15a is preset in the operation table for each target output.

In the combustion operation based on the operation table, when the flame temperature of the combustion unit is risen by a certain temperature or more from the reference temperature due to the increase in combustion output, the control unit 6 determines that the remaining amount of LP gas has decreased, and notifies of a lowering in the remaining amount. For example, in a case where the target output is the maximum heating value of the combustion device 10, when a rise of 30° C. or more is detected as a certain temperature relative to a set reference temperature A [°C] of the flame of the combustion unit, the control unit 6 determines that the combustion output is risen by a certain amount or more from the reference value due to the decrease in the remaining amount of LP gas. Moreover, the control unit 6 notifies of a lowering in the remaining amount in the gas cylinder from the operation terminal 6a, for example, by display or voice output. The certain temperature corresponds to a temperature rise when the combustion output has risen by a reference value, and is preset by the experiment for each target output, for example.

Further, the control unit 6 starts combustion operation based on the operation table, and adjusts the opening of the gas proportional valve 16 and the rotational speed of the combustion fan 13 according to the flame temperature of the combustion unit or the temperature detected by the first hot water tapping temperature sensor 5b, for example, so as to control the combustion operation such that the combustion output matches the target output. The control unit 6 may also use the combustion fan 13 as the output detection part. For example, when the remaining amount of LP gas in the gas cylinder decreases and the combustion output rises, the control unit 6 controls the combustion operation so as to lower the combustion output by decreasingly correcting the rotational speed of the combustion fan 13.

When decrease correction is made to reduce the rotational speed of the combustion fan 13 by a certain amount or more from the reference rotational speed set in the operation table, the control unit 6 determines that the combustion output is risen by a certain amount or more from the reference value due to the decrease in the remaining amount of LP gas, and notifies of a lowering in the remaining amount in the gas cylinder from the operation terminal 6a. The decrease correction of the certain rotational speed corresponds to the rotational speed of the combustion fan 13 to be decreased such that the combustion output risen by the reference value is matched with the target output, and is preset based on the combustion experiment for each target output, for example. Moreover, the rate of decrease in the rotational speed may be set as a criterion for determination.

Further, the control unit 6 starts combustion operation based on the operation table, and adjusts the opening of the gas proportional valve 16 and the rotational speed of the combustion fan 13 according to the flame temperature of the combustion unit or the temperature detected by the first hot water tapping temperature sensor 5b, for example, so as to control the combustion operation such that the combustion output matches the target output. The control unit 6 may also use the gas proportional valve 16 as the output detection part. For example, when the remaining amount of LP gas in the gas cylinder decreases and the combustion output rises, the control unit 6 controls the combustion operation so as to lower the combustion output by decreasingly correcting the opening of the gas proportional valve 16.

When decrease correction is made to reduce the opening of the gas proportional valve 16 by a certain amount or more from the reference opening set in the operation table, the control unit 6 determines that the combustion output is risen by a certain amount or more from the reference value due to the decrease in the remaining amount of LP gas, and notifies of a lowering in the remaining amount in the gas cylinder from the operation terminal 6a. The decrease correction of the certain opening corresponds to the opening of the gas proportional valve 16 to be decreased such that the combustion output risen by the reference value is matched with the target output. For example, in a case where the opening is specified by the number of steps, the certain opening is preset based on the combustion experiment for each target output according to the number of steps. Moreover, the rate of decrease in the opening may also be set as a criterion for determination.

The hot water supply device 1 heats tap water in the heat exchange unit 3 using the combustion heat of the combustion device 10, mixes the tap water with the hot water heated in the hot water tapping unit 5, and supplies the temperature-controlled hot water to the outside. According to the target output of the combustion device 10 for supplying the hot water having the target hot water supply temperature to the outside, the control unit 6 adjusts the mixing ratio for mixing tap water so as to adjust the combustion output of the combustion device 10 and the temperature of the hot water.

The control unit 6 starts combustion operation based on the operation table for combustion operation, and controls the combustion operation so as to reduce the difference between the combustion output calculated by the control unit 6 based on the water supply flow rate, the water supply temperature, and the temperature of the hot water heated by the heat exchange unit 3 and the target output. The control unit 6 may also use the water supply flow rate sensor 4c, the water supply temperature sensor 4b, and the first hot water tapping temperature sensor 5b for detecting the water supply flow rate, the water supply temperature, and the temperature of the hot water heated in the heat exchange unit 3 as the output detection part. For example, when the remaining amount of LP gas in the gas cylinder decreases, the calculated combustion output rises, therefore the control unit 6 determines that the remaining amount of LP gas has lowered when there is a rise in the combustion output by the reference value or more relative to the target output, and notifies of a lowering in the remaining amount.

The operation and effects of the combustion device 10 will be described hereinafter.

When performing the combustion operation based on the operation table, in a case where the combustion output detected by the output detection part (the flame temperature sensor 18, the combustion fan 13, and the gas proportional valve 16) is risen by a reference value or more, the control unit 6 of the combustion device 10 notifies that the remaining amount of LP gas in a gas cylinder has lowered and is getting less. As the remaining amount of LP gas in the gas cylinder decreases and the time to replace the LP gas approaches, the proportion of butane having a large heating value relative to the main component propane increases. Thus, since the combustion output increases more than the combustion operation based on the operation table, the control unit 6 is capable of detecting that the remaining amount of LP gas has decreased by detecting the combustion output through the output detection part, and notifying the arrival of the time to replace the gas cylinder and prompting the replacement of the gas cylinder by notifying of a lowering in the remaining amount of LP gas.

The control unit 6 performs the combustion operation based on the operation table, and determines that the combustion output is risen by the reference value or more when the temperature of the combustion unit is risen by a certain amount or more from the reference temperature set in the operation table of the flame temperature sensor 18. Therefore, the control unit 6 is capable of notifying of a lowering in the remaining amount of LP gas that causes the combustion output to rise by the reference value or more, and prompting the replacement of the gas cylinder.

When performing combustion operation based on the operation table and adjusting the adjusting the combustion output to reach the target output, in a case where the rotational speed of the combustion fan 13 is decreasingly corrected by a certain amount or more from the reference rotational speed set in the operation table so as to lower the combustion output, the control unit 6 determines that the combustion output is risen by the reference value or more. Therefore, the control unit 6 is capable of notifying of a lowering in the remaining amount of LP gas that causes the combustion output to rise by the reference value or more, and prompting the replacement of the gas cylinder.

When performing combustion operation based on the operation table and adjusting the combustion output to reach the target output, in a case where the opening of the gas proportional valve 16 is decreasingly corrected by a certain amount or more from the reference opening set in the operation table so as to lower the combustion output, the control unit 6 determines that the combustion output is risen by the reference value or more. Therefore, the control unit 6 is capable of notifying of a lowering in the remaining amount of LP gas that causes the combustion output to rise by the reference value or more, and prompting the replacement of the gas cylinder.

The combustion device 10 may also be installed in a heating device such as a gas fan heater, for example. Moreover, those skilled in the art may implement various modifications to the above embodiments without departing from the scope of the disclosure, and the disclosure includes such modifications.

What is claimed is:

1. A combustion device for burning LP gas filled in a gas cylinder as fuel in a combustion unit, the combustion device comprising:
a control unit for controlling a combustion operation based on a preset operation table such that a combustion output reaches a target output, and an output detection part for detecting the combustion output,
wherein in response to the combustion output detected by the output detection part being risen by a reference value or more relative to the target output, the control unit notifies of a lowering in a remaining amount of LP gas in the gas cylinder.

2. The combustion device according to claim 1, comprising:
a flame temperature sensor for detecting a flame temperature in the combustion unit as the output detection part,
wherein when controlling the combustion operation based on the operation table, in response to a temperature detected by the flame temperature sensor being risen by a certain amount or more from a reference temperature, the control unit determines that the combustion output is risen by a reference value or more.

3. The combustion device according to claim 1, comprising:
a combustion fan for supplying combustion air to the combustion unit as the output detection part,
wherein when controlling the combustion operation based on the operation table and adjusting the combustion output so as to reach the target output, in response to a rotational speed of the combustion fan being decreasingly corrected by a certain amount or more from a reference rotational speed, the control unit determines that the combustion output is risen by a reference value or more.

4. The combustion device according to claim 1, comprising:
a gas proportional valve for adjusting a supply flow rate of the LP gas as the output detection part,
wherein when controlling the combustion operation based on the operation table and adjusting the combustion output so as to reach the target output, in response to an opening of the gas proportional valve being decreasingly corrected by a certain amount or more from a reference opening, the control unit determines that the combustion output is risen by a reference value or more.
